(19) United States
(12) Patent Application Publication
(10) Pub. No.: US 2012/0321843 A1
(43) Pub. Date: Dec. 20, 2012

(54) Perforated Cover for Slicing Machine

(76) Inventors: Edward Dean McLean, Waiuku (NZ); Luke Adrian Burford-Firmin, Waiuku (NZ)

(21) Appl. No.: 13/159,426

(22) Filed: Jun. 14, 2011

(51) Int. Cl. B32B 3/10

(52) U.S. Cl. 428/131

(57) ABSTRACT

This invention relates to a perforated cover which is retrofitted to a slicing machine for meat and other foods. The perforated cover may be made from metal and non-metal materials. The perforated cover is designed to be removed from the slicing machine so that the perforated cover and slicing machine can be cleaned. The perforated cover acts as a protective shield for the operator's hands and fingers while the operator is using the slicing machine. The perforated cover is attached to the slicing machine and moves with the slicing machine thus allowing the operator to use the slicing machine while the perforated cover is in place. Technology has evolved where a cutting system can accurately insert perforations in materials during manufacture which allows the operator to see through the perforated cover while the slicing machine is being operated. In addition the perforations reduce the weight of the perforated cover which makes the perforated cover easier to remove and carried by humans.

### TECHNICAL FIELD

Mechanical engineering. This invention relates to a perforated cover which is retrofitted to a slicing machine for meat and other foods.

### BACKGROUND

Technology has evolved where a cutting system can accurately insert perforations in materials during manufacture which allows the operator to see through the perforated cover while the slicing machine is being operated. In addition the perforations reduce the weight of the perforated cover which makes the perforated cover easier to remove and carried by humans.

### SUMMARY OF INVENTION

### Technical Problem

This invention relates to a perforated cover which is retrofitted to a slicing machine for meat and other foods. There have been numerous coverings developed that provide one or the other features set out in “Solution to Problem” and “Advantageous Effects of Invention” but not all features in one covering. Such coverings have proved to be too cumbersome, provide inadequate protection for the operator, have poor durability due to the techniques or procedures followed and/or materials used to manufacture the coverings, too bulky as the coverings take up too much space around the slicing machine, are designed to keep the operator away from the slicing machine rather than provide protection during use of the slicing machine, obstruct operator while using the slicing machine.

### Solution to Problem

Technology has evolved where a cutting system can accurately insert perforations in materials during manufacture which allows the operator to see through the perforated cover while the slicing machine is being operated. In addition the perforations reduce the weight of the perforated cover which makes the perforated cover easier to remove and carried by humans. The overall size of the perforated cover is described as being compact.

### Advantageous Effects of Invention

The perforated cover may be made from metal and non-metal materials. The perforated cover is designed to be removed from the slicing machine so that the perforated cover and slicing machine can be cleaned. The perforated cover acts as a protective shield for the operator's hands and fingers while the operator is using the slicing machine. The perforated cover is attached to the slicing machine and moves with the slicing machine thus allowing the operator to use the slicing machine while the perforated cover is in place. The perforated cover does not impair or obstruct the operator's ability to use the slicing machine.

### BRIEF DESCRIPTION OF DRAWINGS

To assist with understanding the invention, reference will be made to the accompanying drawings. In all drawings, the black lines represent the perforated cover, the grey or shaded lines represent the slicing machine.

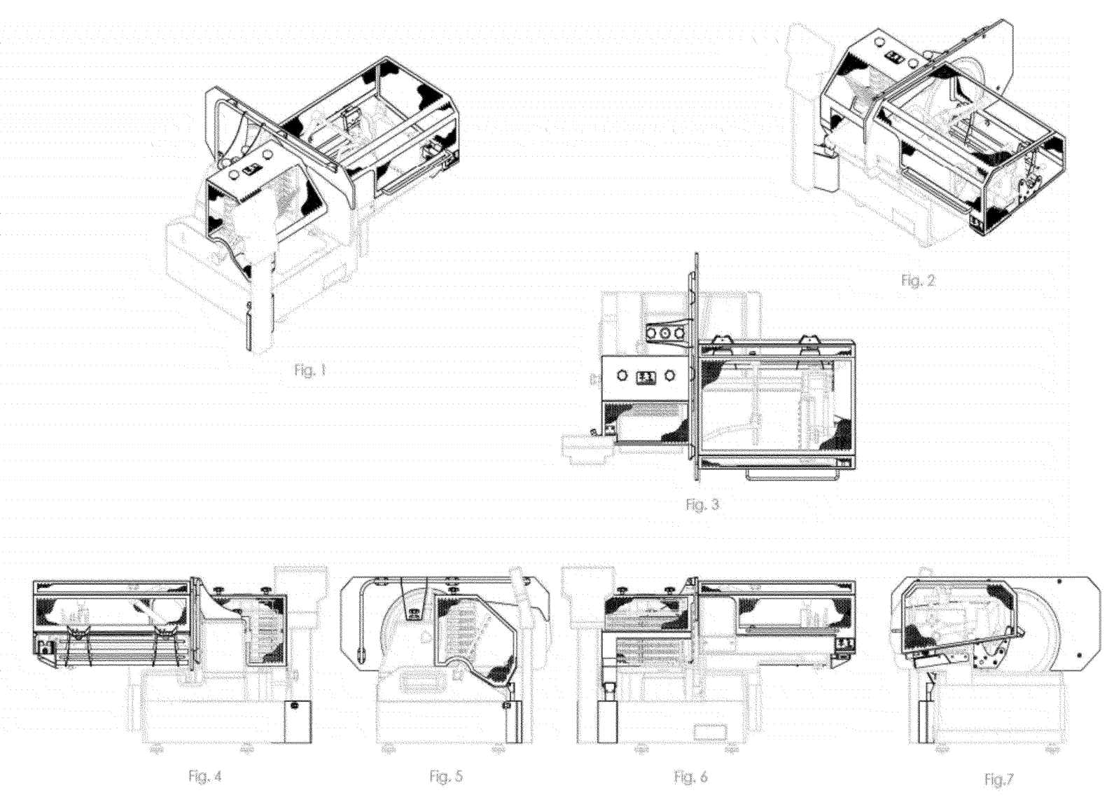

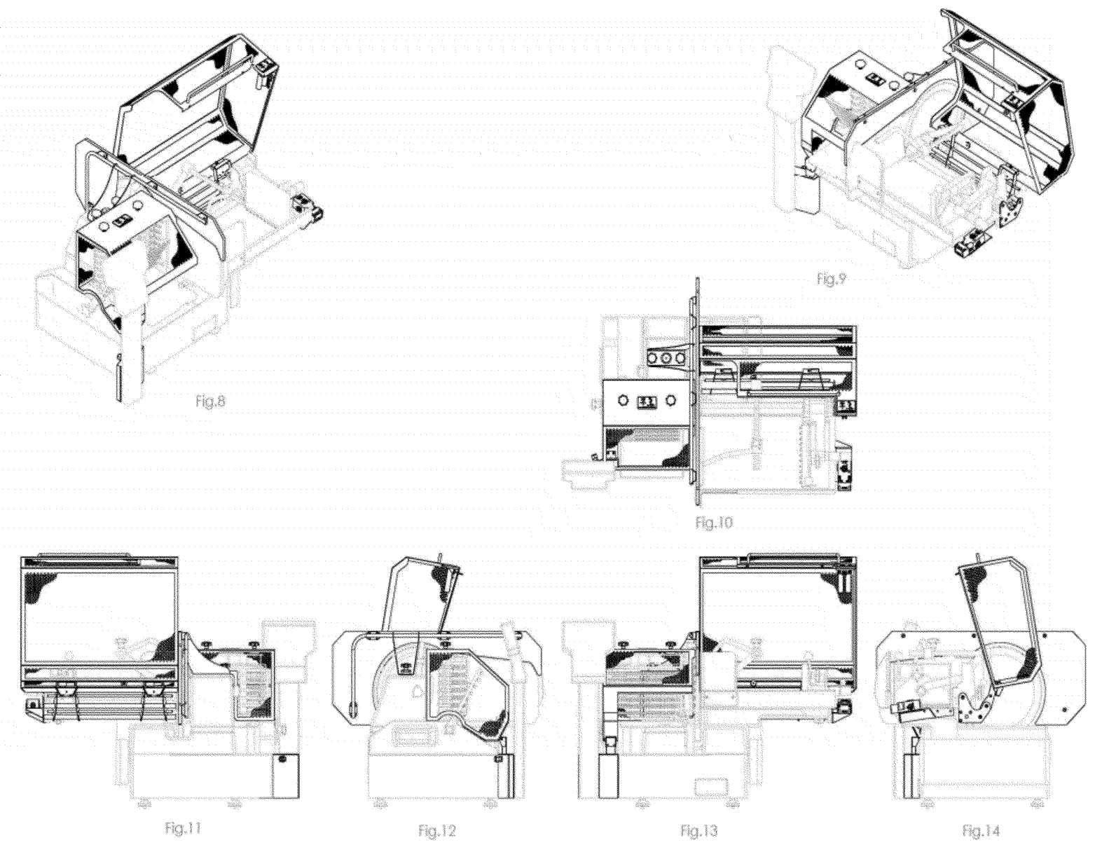

{FIG. 1, FIG. 2, FIG. 3, FIG. 4, FIG. 5, FIG. 6, FIG. 7} Illustrate the perforated cover placed on the slicing machine.

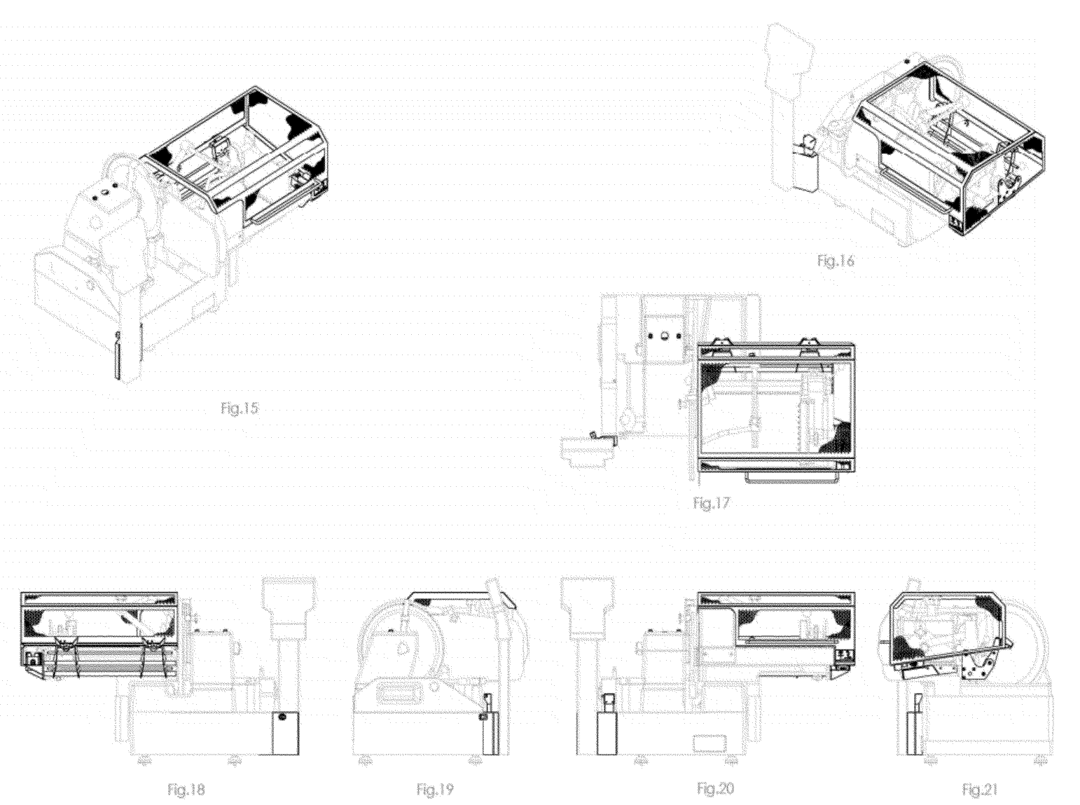

{FIG. 8, FIG. 9, FIG. 10, FIG. 11, FIG. 12, FIG. 13, FIG. 14} Illustrate the perforated cover in its open position on the slicing machine.

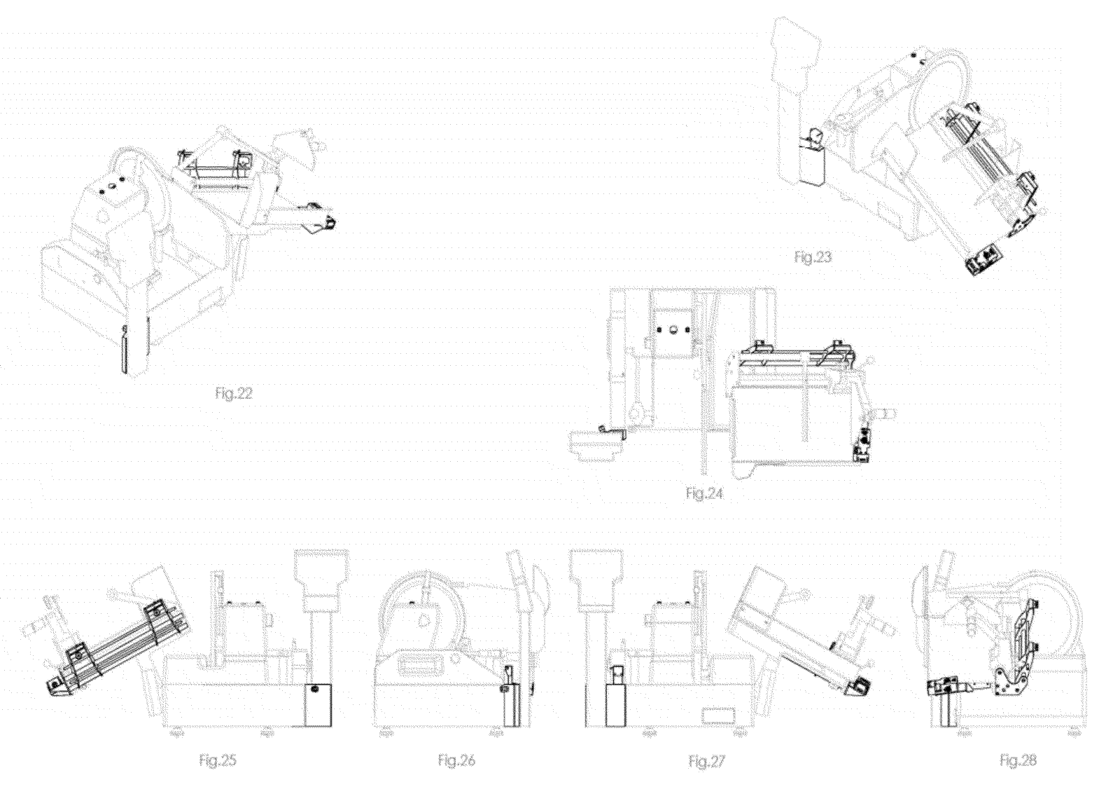

{FIG. 15, FIG. 16, FIG. 17, FIG. 18, FIG. 19, FIG. 20, FIG. 21} Illustrate the perforated cover in a position to allow the blade on the slicing machine to be sharpened.

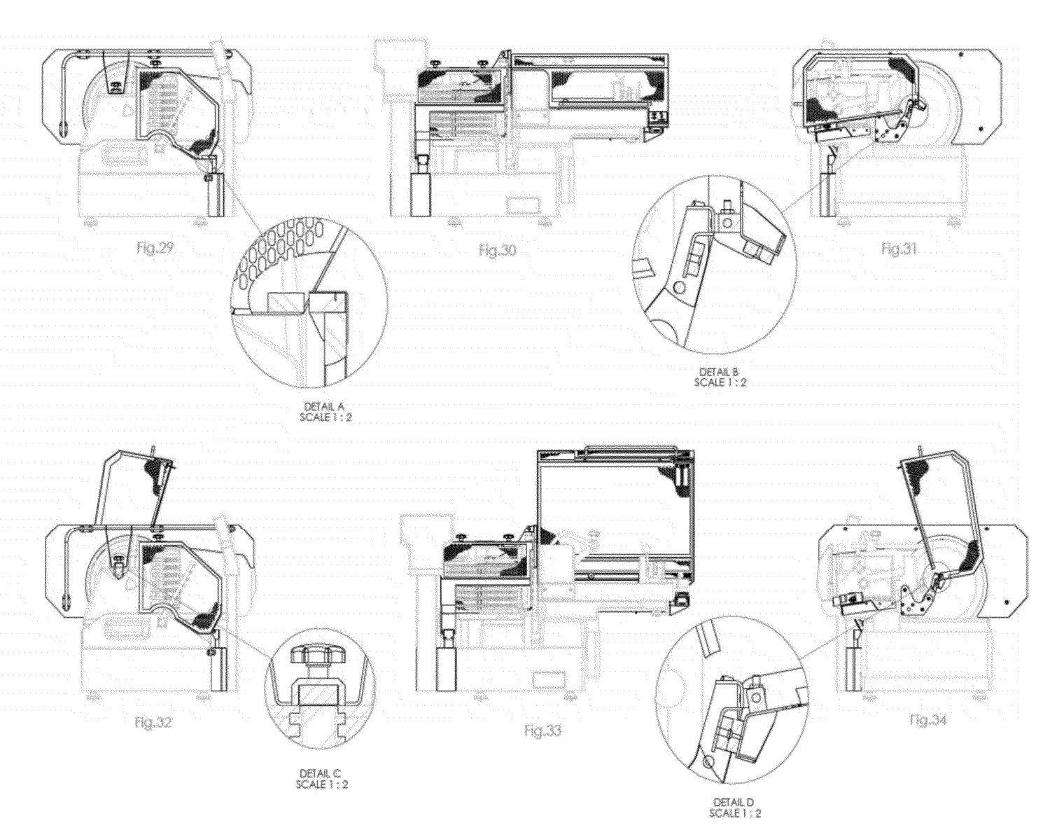

{FIG. 22, FIG. 23, FIG. 24, FIG. 25, FIG. 26, FIG. 27, FIG. 28} Illustrate the perforated cover in a position to allow the slicing machine to be cleaned.

1. This invention a perforated cover which is retrofitted to a slicing machine for meat and other foods.

2. The perforated cover may be made from metal and non-metal materials.

3. The perforated cover is designed to be removed from the slicing machine so that the perforated cover and slicing machine can be cleaned.

4. The perforated cover acts as a protective shield for the operator's hands and fingers while the operator is using the slicing machine.

5. The perforated cover is attached to the slicing machine and moves with the slicing machine thus allowing the operator to use the slicing machine while the perforated cover is in place. The perforated cover does not impair or obstruct the operator's ability to use the slicing machine.

6. Magnetic switches are attached to the perforated cover to hold the perforated cover in place on the slicing machine. The magnetic switches will not allow the slicing machine to work until the perforated cover is fitted onto the slicing machine properly and the magnetic switches are connected.

7. When the operator is loading product, the perforated cover is opened using a hinge system and the magnetic switches attached to the perforated cover to hold the perforated cover in place on the slicing machine prevent the operation of the slicing machine during product loading as the magnetic switches are not connected.

8. When cleaning the slicing machine, the perforated cover may be disconnected from the slicing machine as spring loaded latches break the connection between the perforated cover and the slicing machine. The magnetic switches attached to the perforated cover to hold the perforated cover in place on the slicing machine prevent the operation of the slicing machine during cleaning as the magnetic switches are not connected.
